(19) United States
(12) Patent Application Publication
(10) Pub. No.: US 2017/0108435 A1
(43) Pub. Date: Apr. 20, 2017

(54) Fluorometer

(71) Applicant: University of Alaska, Fairbanks, Fairbanks, AK (US)

(72) Inventor: Matthew Anctil, Fairbanks, AK (US)

(21) Appl. No.: 14/882,839

(22) Filed: Oct. 14, 2015

(51) Int. Cl. G01N 21/64; B01L 3/00

(52) U.S. Cl. CPC G01N 21/645; B01L 3/502715; G01N 21/6428; B01L 2200/10; B01L 2300/0816; B01L 2300/0654; B01L 2300/168; B01L 2300/0609; G01N 2021/6439; G01N 2021/6471; G01N 2201/062; G01N 2201/068; G01N 2201/12

(57) ABSTRACT

A fluorometer can comprise a microfluidics chip receptacle configured to receive a microfluidics chip. The fluorometer can comprise a reflective enclosure that has an outer surface and an inner surface. The microfluidics chip receptacle can be configured in relation to the reflective enclosure so that the reflective enclosure can receive, at the inner surface, light energy emitted from an analyte on a microfluidics chip disposed in the microfluidics chip receptacle. The fluorometer can comprise an excitation source configured to emit excitation energy to the microfluidics chip receptacle. The fluorometer can comprise a light sensor configured in relation to the microfluidics chip receptacle to receive light energy from the microfluidics chip receptacle. The light energy, caused by the excitation energy, is emitted from an analyte. The fluorometer can comprise a controller configured to determine a concentration of an analyte from the light energy received at the light sensor.

### BACKGROUND

LOC (Lab on a Chip) technologies have become very popular in the past few years. Many of these devices utilize microfluidics in conjunction with other technologies to perform a task which would otherwise require the use of several technologies which are bench top laboratory tools. LOC devices are self-contained, and they perform a specific series of tasks to perform an assay. Sometimes these LOC technologies require an analysis device to interpret the assay results such as determining chemical concentration levels. Current devices and technologies appear to be lacking in efficient point of care (POC) technologies which are small enough to be carried as a standard tool, efficient enough to operate under its own internalized power system for extended periods of use, quick enough to use in emergency situations, and powerful enough to perform a variety of diagnostic tests. These and other shortcomings of the prior art are identified and addressed by the present disclosure.

### SUMMARY

It is to be understood that both the following general description and the following detailed description are exemplary and explanatory only and are not restrictive. Provided are methods and systems for fluorometery. In an aspect, a fluorometer is described. The fluorometer can comprise a microfluidics chip receptacle configured to receive a microfluidics chip. The fluorometer can comprise a reflective enclosure that has an outer surface and an inner surface. At least a portion of the inner surface of the reflective enclosure can comprise a reflective material. The microfluidics chip receptacle can be configured in relation to the reflective enclosure so that the reflective enclosure can receive, at the inner surface, light energy emitted from an analyte on a microfluidics chip disposed in the microfluidics chip receptacle. The fluorometer can comprise an excitation source configured to emit excitation energy to the microfluidics chip receptacle. The fluorometer can comprise a light sensor configured in relation to the microfluidics chip receptacle to receive light energy from the microfluidics chip receptacle. The light energy, caused by the excitation energy, is emitted from an analyte. The fluorometer can comprise a controller having a memory comprising computer readable instructions and a processor that, when executing the computer readable instructions, can be configured to determine a concentration of an analyte from the light energy received at the light sensor. In an aspect, the fluorometer can comprise a handheld housing in which the fluorometer described above can be configured. The fluorometer can comprise a user interface configured to provide the concentration of the analyte to a user.

In an aspect of the present disclosure, a method can be performed by the fluorometer. The fluorometer can receive a microfluidics chip, comprising an analyte, relative to a reflective enclosure comprising an inner surface and an outer surface. At least a portion of the inner surface can comprise a reflective material The microfluidics chip can be received relative to the reflective enclosure such that light energy emitted by the analyte is collected in the reflective enclosure. An excitation source can apply excitation energy to the analyte of the microfluidics chip. A light sensor of the fluorometer can receive light energy emitted by the analyte and collected by the reflective enclosure. The light energy can be emitted as a result of the excitation energy applied to the analyte. A controller of the fluorometer can determine a concentration of the analyte based on the light energy received at the light sensor.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an example fluorometer;

FIG. 2 is a perspective, exploded view of an example fluorometer;

FIG. 3 is a perspective, exploded view of an example fluorometer;

FIG. 4A is a block diagram of an example microfluidics chip;

FIG. 4B is a block diagram of an example microfluidics chip;

FIG. 5 is a flowchart of an example method; and

FIG. 6 is a block diagram of an example computer device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, solid-state drives, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to systems and methods of fluorometry for analyzing the concentration of an analyte in a sample. An analyte can comprise a chemical of interest and/or a fluorophore. The present methods and systems disclose a fluorometer that is handheld. The fluorometer comprises a reflective enclosure that comprises an outer surface and an inner surface. At least a portion of the inner surface comprises a reflective material. In an aspect, the reflective enclosure is configured to receive light energy emitted by a sample of the analyte. For example, the reflective enclosure can comprise a microfluidics chip receptacle configured in relation to the reflective enclosure so that light energy emitted by an analyte disposed on a microfluidics chip in the microfluidics chip receptacle can be received by the inner surface of the reflective enclosure. The microfluidics chip receptacle can be configured to receive a microfluidics chip on which the sample of the analyte can be disposed. In an aspect, a pump can be in fluid communication with the microfluidics chip receptacle to circulate a fluid (e.g., gas and/or liquid) through a microfluidics chip receptacle and a microfluidics chip disposed in the microfluidics chip receptacle. In an aspect, the microfluidics chip receptacle can further comprise an inlet and an outlet to the microfluidics chip for a pump to circulate fluids to the microfluidics chip. The fluid can comprise the analyte. In an aspect, an excitation source can be configured with respect to the microfluidics chip receptacle to provide excitation energy (e.g., light, electricity, and the like) to the microfluidics chip receptacle. The excitation energy, if applied to the analyte, can cause light energy to be emitted from the analyte. In an aspect, a light sensor can be configured in relation to the reflective enclosure to receive the light energy caused by the excitation source and received by the reflective enclosure. The reflective enclosure can reflect the light energy emitted from the analyte to improve the resolution and sensitivity of the fluorometer by directing more of the light energy to the light sensor. The light sensor can be in signal communication with a controller comprising a memory computer readable instructions and a processor, which when executing the computer readable instructions, is configured to determine a concentration of an analyte based on the light energy received by the light sensor. For example the greater the intensity of the light energy received the greater the concentration of the analyte. In an aspect, the fluorometer can comprise one or more light filters. In an aspect, the excitation source can be a light source and a first filter can be configured to restrict a band of wavelengths of light energy, generated by the light source, from being received by the microfluidics chip receptacle and in turn the analyte. In an aspect, a second filter can be configured, in relation to the light sensor, to restrict a band of wavelengths of light energy, generated by the light source, from being received by the light sensor. In an aspect, the second filter can be configured to differentiate between an analyte of interest and other fluorescent/phosphorescent chemicals present in the sample which emit light energy at wavelengths different from the wavelengths of light energy emitted by the analyte of interest.

Discrete sampling of analytes using a photoluminescence technique has a wide range of applications in biological, chemical, and clinical sciences. Examples described herein reference biological sampling of chemicals produced by cells. However, other uses of the systems and methods described herein are considered. Abnormal production activity from a cell or group of cells is detrimental to the health of an organism and can be the result of an infection or from genetic or epigenetic mutations. Many biological chemicals have been discovered and markers have been developed to identify several of these chemicals either specifically to a unique chemical or to a family of chemicals. These markers can be used in Enzyme Linked Immunoassays (ELISA). Using the ELISA technique in conjunction with the methods and systems described herein can allow a user of the fluorometer to quantitatively determine the concentration of a particular chemical or chemical family in a sample but also allows the user to see a real time production reaction to a given stimulus.

The fluorometer can be configured to be used in combination with one or several microfluidics chips. The purpose and design of the microfluidics chips can vary based on the target analyte, but any analyte which can be individually and specifically labeled with a fluorophore can be quantitatively measured with the fluorometer. By limiting the size of the fluorometer and the required sample, the fluorometer can be used in a manner such as a diabetic blood sugar test, using a single drop of whole blood, and passing it through a microfluidics chip or a series of chips to separate the blood constituents and analyzing the component of interest such as the plasma or white blood cells. The fluorometer, configured to perform discrete real time sampling of analytes such as the products of living cells, can provide medical practitioners with an affordable tool which the medical practitioners can use to monitor a patient's disease progression or reaction to medical treatments such as anaphylaxis. In another example, the fluorometer can provide various results to the patient in less than an hour without having to send a fairly large sample to a lab for processing. In essence, the fluorometer can bring a portion of the lab into the examination room or into emergency field service.

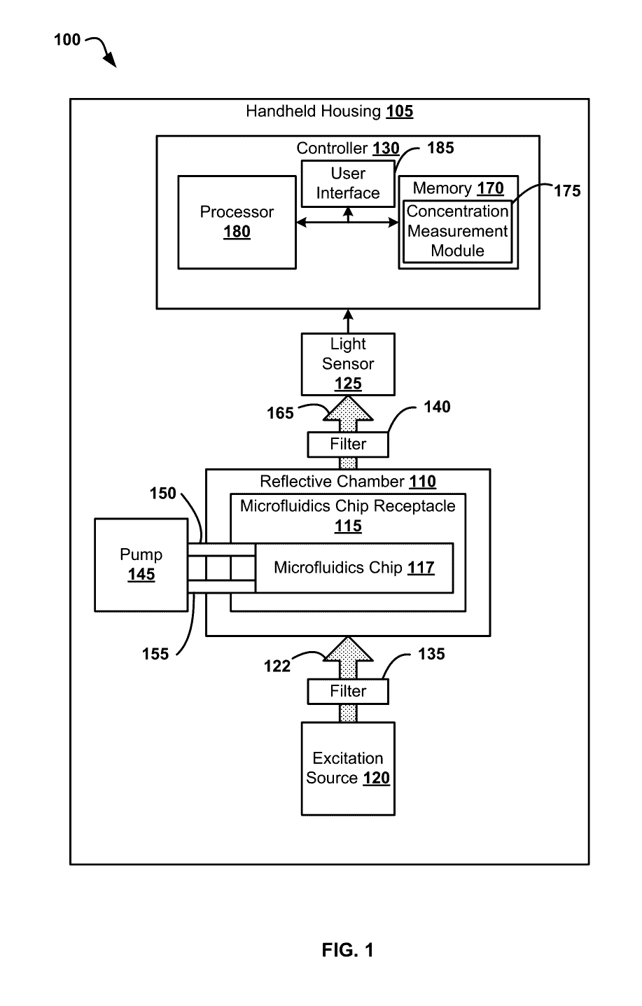

FIG. 1 illustrates a block diagram of an example fluorometer 100 according to an aspect. The fluorometer 100 can comprise a handheld housing 105. Disposed within the handheld housing 105 can be a reflective enclosure 110, a microfluidics chip receptacle 115, an excitation source 120, a light sensor 125, and a controller 130. In an aspect, the reflective enclosure 110 can comprise an inner surface and an outer surface. At least a portion of the inner surface can comprise a reflective material. For example, the reflective material can be mirrors. The minors can be polycarbonate plastic with one side covered in a silver mirror coating. In an aspect, the reflective material can comprise metals and metal alloys such as chrome, mercury, aluminum, nickel, platinum, rhodium, tantalum, zinc, tin, magnesium, ruthernium, palladium, osmium, iridium, combinations thereof, and the like. In an aspect, other metals and metal alloys such as gold, copper, bronze, brass, combinations thereof and the like can be used but can absorb some wavelengths of light energy while reflecting others. In an aspect, the reflective enclosure 110 can be formed in a shape of a sphere. However, other shapes are contemplated such as a cube, a rectangular prism, a pyramid, a cylinder, and the like.

In an aspect, the microfluidics chip receptacle 115 can be disposed within the reflective enclosure 110. In an aspect, the microfluidics chip receptacle 115 can be configured in relation to the reflective enclosure 110 (e.g., coupled to the outer surface) so that any light energy emitted from the microfluidics chip receptacle 115 can be received by the inner surface of the reflective enclosure 110. The microfluidics chip receptacle 115 can be configured to receive one or more microfluidics chips 117. The microfluidics chip 117 can comprise a sample of an analyte that the fluorometer 100 can analyze. In an aspect, the microfluidics chip receptacle 115 can be configured to receive any chip that comprises a sample of analyte. In an aspect, the analyte can comprise a chemical of interest and/or fluorophore. In an aspect, the chemical of interest can comprise an amino acid, a protein, a strand of mRNA, an enzyme, chlorophyll, drugs, toxins, combinations thereof and the like. In an aspect the fluorophore can be used to label the chemical of interest. The fluorophore can comprise fluorescent or phosphorescent properties that emit light energy when excited Examples of the analyte can be, but not limited to, fluorescein sodium salt, 2,3-naphthalenecarboxaldehyde (NDA), CYBR green, biotin and the like. Fluorescein sodium salt has a peak excitation wavelength of 490 nm and a peak emission wavelength of 515 nm. NDA can be used as a fluorescent marker to label amino acids such as D-glutamic acid, which occur naturally cells. NDA has an emission wavelength of 480-490 nm when excited with 420 nm wavelength. In an aspect, the fluorophore can comprise an antibody which can be used as an intermediary analyte by binding the chemical of interest to the fluorophore. For example, biotinylated antibodies can comprise the fluorophore biotin and an antibody being an intermediate analyte which binds the biotin to the analyte of interest.

In an aspect, the fluorometer can comprise an excitation source 120. The excitation source 120 can be configured to emit an excitation energy 122 that can be received by the microfluidics chip receptacle 115 so that the excitation energy 122 can interact with the analyte disposed on a microfluidics chip 117. For example the excitation source 120 can be a light source, an electrical excitation source, and the like. The excitation energy 122 can be light energy and/or an electrical current, respectively. In an aspect, the excitation energy 122 can comprise X-ray radiation, infrared radiation, ultraviolet radiation, microwave radiation, chemical reactions, and the like. In an aspect, the excitation source 120 can be disposed in the reflective enclosure 110. In another aspect, the excitation source 120 can be located outside of the reflective enclosure 110 and the reflective enclosure 110 can have an aperture through which the excitation energy 122 can enter the reflective enclosure 110 to interact with the microfluidics chip receptacle 115 and any analyte that may be disposed on the microfluidics chip 117 positioned in the microfluidics chip receptacle 115.

In an aspect, the excitation source 120 can comprise an electrical excitation source. In an aspect, the microfluidics chip 117 can comprise the electrical excitation source. For example, the microfluidics chip 117 can comprise one or more electrical probes. In an aspect, the microfluidics chip receptacle 115 can comprise one or more electrical connectors that can be in electrical communication with the controller 130. The one or more electrical probes of the microfluidics chip 117 when disposed in the microfluidics chip receptacle 115 can come into electrical communication with the one or more electrical connectors. In an aspect, the a wireless electrical connection between the receptacle and the chip is contemplated. In an aspect, the controller 130 can control the electrical excitation generated by the electrical excitation source and provide an electrical signal to an analyte disposed on the microfluidics chip 117.

In an aspect, the electrical signal applied to the sample of the analyte by the electrical excitation source can comprise a electrical current that passes through the sample of the analyte. The electrical current can transfer electrical energy to the based on the resistance of the sample of the analyte. The electrical energy transferred to the sample of the analyte can be converted to thermal energy, light energy, chemical energy, combinations thereof, and the like. The electrical energy transferred to the sample of the analyte can cause an electron of a fluorophore of the analyte to temporarily move to a higher electron orbital and when the electron moves back to a stable position, light energy is emitted from the fluorophore.

In an aspect, the excitation source 120 can comprise a tight source. As an example, the light source can be an LED. However, other light sources are contemplated such as, but not limited to, an LED laser, a monochromatic laser, a chemoluminescence source, a combustion source, an incandescent light, a fluorescent light, combinations thereof, and the like. In an aspect, using an LED as the light source can result in low power consumption, LEDs have a long physical life, and LEDs are small in size to fit in a fluorometer 100 that is handheld. However, LED light sources can emit a broad spectrum light. The light is not restricted to a single wavelength like traditional monochromatic lasers. Therefore, when using an LED light source for the purpose of fluorometric analysis, one or more light filters can be used to restrict the band of wavelengths of light energy from being received by the analyte of interest to those wavelengths that are useful as excitation energy 122 white blocking/reflecting those that are not useful as excitation energy 122.

In an aspect, if the excitation source 120 is a light source emitting a broad spectrum of light, the fluorometer 100 can comprise a first filter 135 and/or a second filter 140. The first filter 135 can be positioned over the light source or between the light source and the microfluidics chip receptacle 115. The first filter 135 can restrict a first band of wavelengths of tight energy emitted from the light source to a second band of wavelengths of light energy that are of interest as excitation energy 122. In an aspect, the second filter 140 can be positioned over the light sensor 125. The light sensor 125 can receive light energy 165 emitted from the analyte of the sample disposed in the microfluidics chip 117 in the microfluidics chip receptacle 115. The light energy 165 emitted from the analyte can result from light energy that is excitation energy 122 from the light source being absorbed by the analyte because of a phenomenon called photo fluorescence and/or phosphorescence. In photo fluorescence and/or phosphorescence, light energy is absorbed by a chemical, such as a fluorophore, by raising an electron from one or more atoms in the chemical to a higher orbital shell. Light energy is then released at a different wavelength than the light energy being absorbed when the electron collapses back to a stable position. In an aspect, a fluorophore can be attached to an analyte. Therefore, any light energy emitted from the fluorophore can be indicative of the presence of the analyte and concentration of the analyte can be determined based on the intensity of the light energy emitted by the fluorophore. Although, the fluorophore emits the light energy, as described herein, the light energy is emitted by an analyte which can be a fluorophore or comprise a fluorophore.

In an aspect, the wavelengths of light energy of interest are those emitted by the analyte. The light sensor 125 can detect these wavelengths of light energy emitted from the analyte. The wavelengths of light energy emitted can be used to determine the concentration of the analyte. However, the light sensor 125 can also receive the light energy emitted from the light source resulting in contaminated results in a sampling of light energy by the light sensor 125. Therefore, the second filter 140 can be configured to block bands of the wavelengths of light energy from the light source but allow the bands of the wavelengths of light energy emitted from the analyte to pass through the second filter to the light sensor 125.

In an aspect, the light sensor 125 can be positioned inside the reflective enclosure 110 to receive the light energy emitted from the analyte. In an aspect, the light sensor 125 can be positioned outside the reflective enclosure 110 and the reflective enclosure 110 can comprise an aperture through which the light energy can pass through to be received by the light sensor 125. The light sensor 125 can comprise any sensor that can convert light energy 165 to electrical energy such as, but not limited to, a photo-multiplier tube, a photo-diode, a photo-transistor, a CdS photocell, a photo-conductor, an integrated circuit, a sensor electronic assembly, a complimentary metal-oxide semiconductor (CMOS) sensor, a charged coupled device (CCD), combinations thereof, and the like.

In an aspect, the light sensor 125 can be in signal communication with the controller 130. Once the light sensor 125 receives light energy 165, the light sensor 125 can convert the light energy to an electrical signal that can be transmitted and received by the controller 130. In an aspect, the controller 130 can comprise a memory 170 and a processor 180. In an aspect, the memory 170 can comprise a concentration measurement module 175 having computer readable instructions that when executed on the processor 180 determine a concentration of the analyte based on the received light energy 165 at the light sensor 125 by analyzing the electrical signal received from the light sensor 125. For example, more intense light energy 165 can be generated when there are higher concentrations of the analyte in the microfluidics chip 117. The more intense light energy 165 can cause the tight sensor 125 to produce more electrical energy. Based on the electrical signal produced by the light sensor 125 the controller 130 can determine the concentration of an analyte. In an aspect, the controller 130 can determine based on the concentration the presence or absence of a chemical. In an aspect, the controller 130 can also comprise a user interface 185 at which the controller 130 can provide the user concentration measurements of the analyte to the user. The user interface 185 can also be configured to receive inputs from the user to control the fluorometer 100.

In an aspect, the fluorometer 100 can comprise a pump 145. The pump 145 can be in fluid communication with the microfluidics chip receptacle 115 to circulate one or more fluids (e.g., a liquid, a gas) through the microfluidics chip 117. In an aspect, one or more inlet channels 150 and one or more outlet channels 155 can facilitate the fluid communication between the pump 1.45 and the microfluidics chip receptacle 115. As an example, the pump 145 can continuously move a sample fluid comprising the analyte of interest. The sample fluid can move over a region of the microfluidics chip 117, which has been coated with capture antibodies. As the sample fluid moves over the capture antibodies, the analyte of interest can bind to the capture antibodies. The capture antibodies can then bind the analyte to a fluorophore that is also pumped over the capture antibodies. In another example, the microfluidics chip 117 can be coated with the analyte. A fluorophore and optionally a capture antibody can be flowed over the analyte to bind the analyte to the fluorophore. The excitation energy 122 can then be applied to the analyte comprising the fluorophore to emit light energy 165 that can be used to determine the concentration of the analyte.

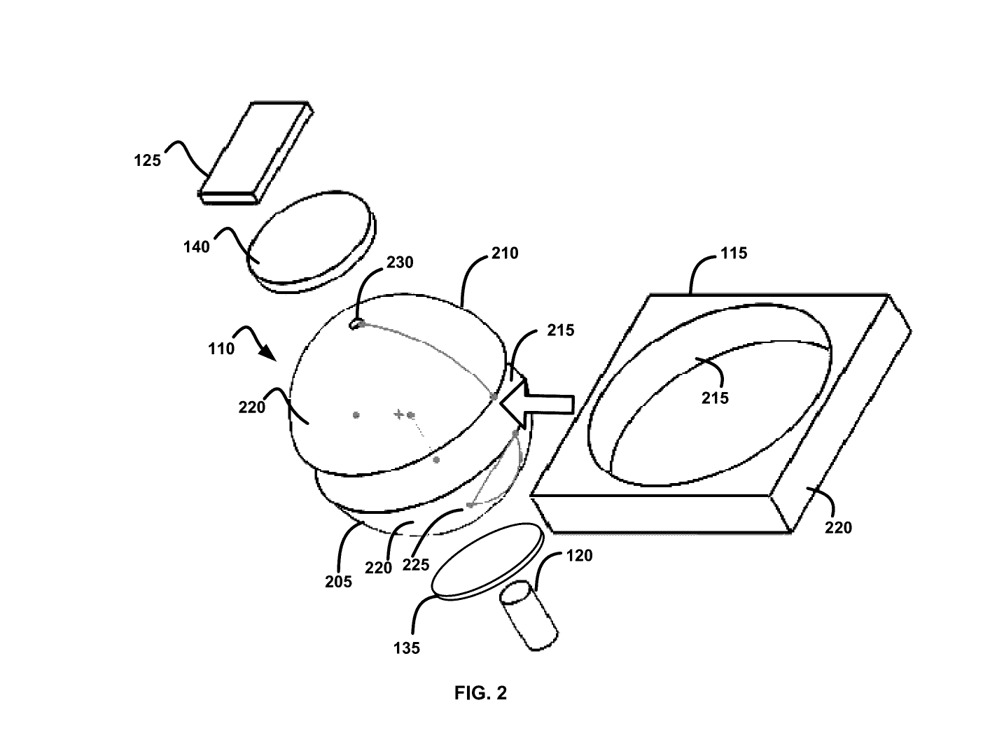

FIG. 2 illustrates a perspective, exploded view of components of the fluorometer 100 of FIG. 1 according to an aspect of the present disclosure. In particular, FIG. 2 illustrates the reflective enclosure 110, the microfluidics chip receptacle 115, the excitation source 120, the first filter 135, the second filter 140, and the light sensor 125. In an aspect, the reflective enclosure 110 can be configured to be substantially spherical. In an aspect, the reflective enclosure 110 can comprise a first semisphere 205 and a second semisphere 210. The first semisphere 205 and the second semisphere 210 of the reflective enclosure 110 can comprise an inner surface 215 and an outer surface 220. At least a portion of the inner surface 215 can comprise a reflective material such as a silver mirror coating. The reflective enclosure 110 comprising the reflective material can help improve the resolution of the emitted light energy from an analyte after the analyte is exposed to excitation energy. In an aspect, the improved resolution can result in more light energy being captured by the light sensor 125. In an aspect, first semisphere 205 can comprise a first aperture 225 for the excitation energy to enter the reflective enclosure 110 to interact with any analyte that is present in the reflective enclosure 110. In an aspect, the second semisphere 210 can comprise a second aperture 230 for light energy emitted from an analyte, as a result of the excitation energy interacting with the analyte, to exit the reflective enclosure 110. The light energy can exit the reflective enclosure 110 to be received by the light sensor 125.

In an aspect, the first filter 135 can be configured to be between the second semisphere 210 and the excitation source 120 to filter bands of wavelengths of light energy caused by the excitation source 120. For example, as illustrated in FIG. 2, the first filter 135 can be positioned between the first aperture 225 and the excitation source 120 to filter the light energy entering the reflective enclosure 110. An analyte disposed in the reflective enclosure 110 can emit light energy caused by a specific band of wavelengths of light energy from the excitation energy. Therefore, the first filter 135 can be configured to block (e.g., restrict, reflect, absorb) wavelengths of light energy that do not cause the light energy to emit from the analyte while allowing wavelengths of light energy that do cause light energy to emit from the analyte to pass through the first filter 135.

In an aspect, the second filter 140 can be configured to be between the first semisphere 205 and the light sensor 125 to filter bands of wavelengths of light energy caused by the excitation source 120. For example, as illustrated in FIG. 2, the second filter 140 can be positioned between the second aperture 230 and the light sensor 125 to fitter the light energy exiting the reflective enclosure 110. The light energy exiting the reflective enclosure 110 can comprise the light energy emitted from the analyte and light energy caused by the excitation source 120. Therefore, the second filter 140 can be configured to block wavelengths of light energy caused by the excitation source 120 and let through wavelengths of light energy emitted from the analyte.

In an aspect, the microfluidics chip receptacle 115 can be configured to be insertable into the reflective enclosure 110. In an aspect, the microfluidics chip receptacle 115 can comprise an inner surface 215 and an outer surface 220. In an aspect, at least a portion of the inner surface 215 can be covered with a reflective material. In aspect, the microfluidics chip receptacle 115, if inserted into the reflective enclosure 110, can be configured to complete the inner surface 215 of the reflective enclosure 110. The inner surface 215 of the reflective enclosure 110 can be continuous between the first semisphere 205 and the second semisphere 210 when the microfluidics chip receptacle 115 is inserted into the microfluidics chip receptacle 115. The microfluidics chip receptacle 115 can be configured to receive a microfluidics chip that can comprise a sample of the analyte.

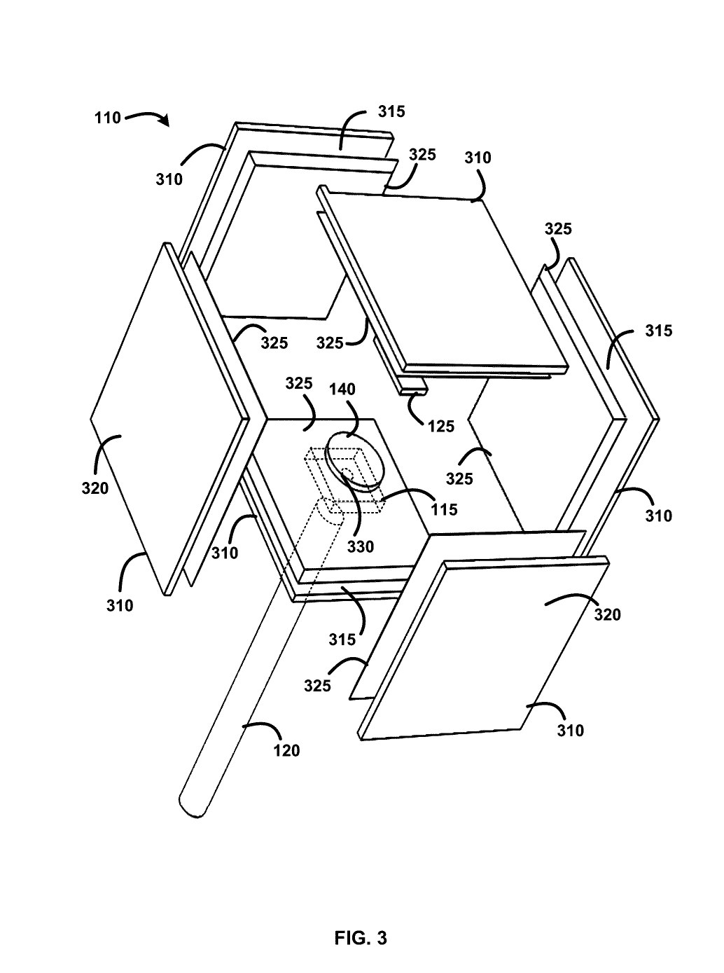

FIG. 3 illustrates a perspective, exploded view of components of the fluorometer 100 of FIG. 1, according to an aspect. In particular, FIG. 3 illustrates a reflective enclosure 110, a microfluidics chip receptacle 115, a second filter 140, an excitation source 120, and a light sensor 125. The reflective enclosure 110 can be configured to receive and contain light emitted from an analyte that can be dispersed in a microfluidics chip. For example the reflective enclosure 110 can provide a small aperture 305 for the light energy to enter directly into the light sensor 125. The reflective enclosure 110 can comprise a cubic base 310 having an inner surface 315 and an outer surface 320.

However, the reflective enclosure 110 can be formed to other shapes that help direct light energy to a light source. The reflective enclosure 110 can comprise one or more reflective/refractive structures 325 coupled to the inner surface 315. The second filter 140 can be applied to the reflective enclosure 110 and the excitation source 120 can provide an excitation energy that can cause light energy to emit from an analyte dispersed in a microfluidics chip in the microfluidics chip receptacle 115. In an aspect, the excitation source 120 can be bonded to microfluidics chip receptacle 115 to provide excitation energy to the microfluidics chip receptacle 115. In an aspect, the microfluidics chip receptacle 115 can be coupled to the outer surface 320 of the cubic base 310 and cover an aperture 330 in the cubic base 310. In an aspect, the second filter 140 can be coupled to the inner surface 315 of the cubic base 310. In an aspect, the second filter 140 can cover the aperture 330 on the inner surface 315. In aspect, the inner surface 315 of the cubic base 310 can comprise a reflective/refractive structure 325 and the aperture 330 can continue through the reflective/refractive structure 325. In an aspect, the second filter 140 can be coupled to the reflective/refractive structure 325 and cover the aperture 330. In an aspect, the light sensor 125 can be coupled to an inner surface 315 or a reflective/refractive structure 325.

In an aspect, a microfluidics chip comprising a sample of an analyte can be placed in the microfluidics chip receptacle 115. The excitation source 120 can be activated and produce and excitation energy that is received by the analyte in the microfluidics chip receptacle 115. The analyte can emit light energy based on the excitation energy. The light energy emitted by the analyte can enter the reflective enclosure 110 through the aperture 330. The light energy can pass through the aperture 330 and through the second filter 140. In an aspect, the reflective enclosure 110 can comprise the second filter 140 as part of the cubic base 310 to allow only certain bands of wavelengths of light energy to enter the reflective enclosure 110. In an aspect, the second filter can be configured to block and/or reflect bands of wavelengths of light energy generated by the excitation source 120 and allow bands of wavelengths of light energy emitted from the analyte to enter the reflective enclosure 110. The reflective enclosure 110 can receive and collect light energy that can be detected by the light sensor 125 that is coupled to the inside of the reflective enclosure 110. The light sensor 125 can convert the light energy to an electrical signal that can be received by a controller and used to determine the concentration of the analyte.

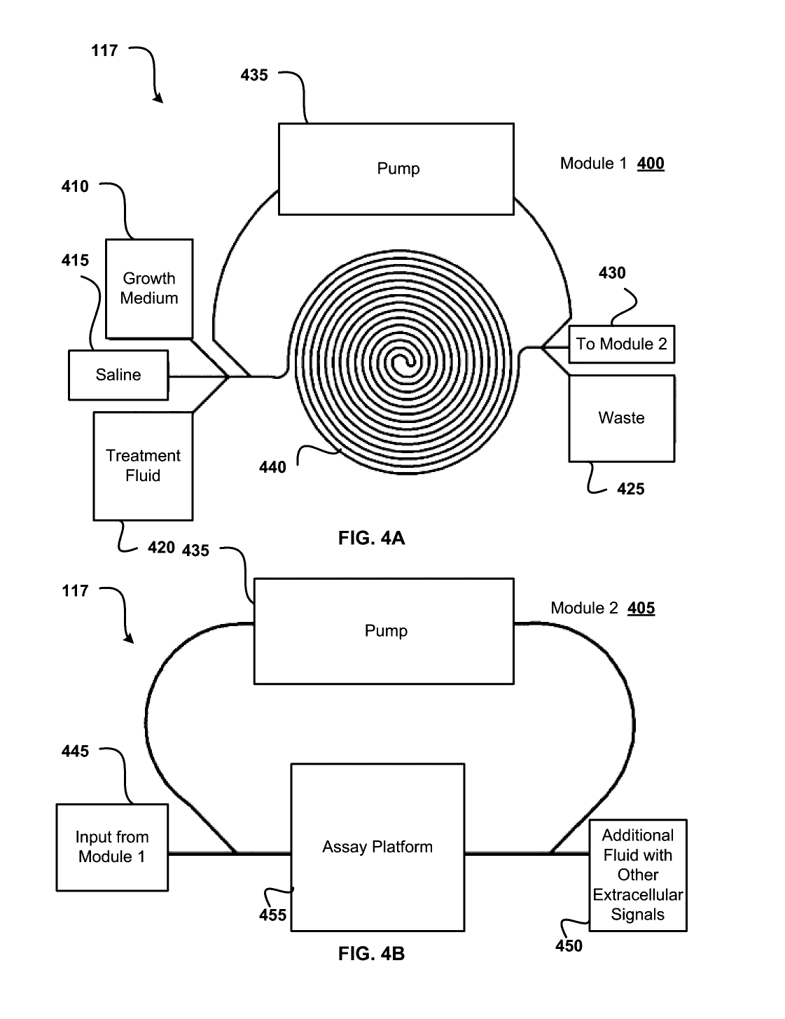

FIGS. 4A and 4B illustrates a microfluidics chip 117 that can be analyzed by the fluorometer 100 of FIG. 1 according to an aspect. The microfluidics chip 117 can be configured to facilitate the use of an assay such as ELISA assays. In an aspect, a microfluidics chip 117 can be configured to use a laser induced fluorescence (LIF) based assays such as LIF capillary electrophoresis. In an aspect, the microfluidics chip 117 can comprise one or more microfluidics chips/modules. FIG. 4A illustrates a first module 400 of the microfluidics chip and FIG. 4B illustrates a second module 405 of the microfluidics chip 117. The microfluidics chip 117 can be configured to contain and prepare a sample of an analyte. The sample of the analyte can be suspended in a homogeneous fluid (e.g., cytokines in extracellular fluid) or part of a solution. For example, bodily fluids such as blood, saliva, sweat, urine, tears, spinal fluid, or breast milk can comprise an analyte of interest. In other examples, water can comprise an analyte of interest such as chlorophyll and other known and unknown chemicals. The first module 400 can comprise inputs for cell care fluids such as a growth medium input 410 and a saline input 415. The first module 400 can also comprise a fluid input 420. The first module 400 can also comprise a waste outlet 425 and a second module outlet 430. The first module 400 can further comprise a pump 435 to circulate one or more input fluids (e.g., growth medium, saline, and treatment fluid). Through a microchannel 440 to the one or more outlets (e,g., second module outlet 430 and waste outlet 425. The microchannel 440 can comprise an analyte such as a small culture of cells for continuous testing of live cells. The curved shape of the microchannel 440 can help promote mixture of fluids. Because the turbulence in the microchannel 440 can be low, combining fluids in a straight channel can require an undesirably long channel. The difference in distance travelled between the surface of an inside track of the microchannel 440 and an outside track of the microchannel 440 can cause the fluid to mix better due to different rates of flow at the inside track and outside track.

FIG. 4B illustrates the second module 405 of the microfluidics chip 117. The second module 405 can comprise a first module input 445. The first module input 445 can be coupled to the second module outlet 430 of FIG. 4A. The second module 405 can comprise one or more additional inputs 450 that provide additional fluid with other analytes of interest or treatment chemicals. The second module 405 can also comprise an assay platform 455 which can be configured as a sample container and observation platform. The second module 405 can be in fluid communication with the pump 435 to continuously move the sample of analyte over the assay platform 455 which is a region of the microfluidics chip 117 comprising a large amount of surface area which can been coated with monoclonal or polyclonal capture antibodies. As the sample of analyte flows over the capture antibodies, the analyte binds to the capture antibodies applied to the surface of the assay platform 455. The capture antibodies can be used as an intermediary to bind the analyte to a fluorophore. The fluorometer 100 of FIG. 1 can be activated and can determine the concentration of the analyte comprising the fluorophore during and/or after the analyte flows over the assay platform 455.

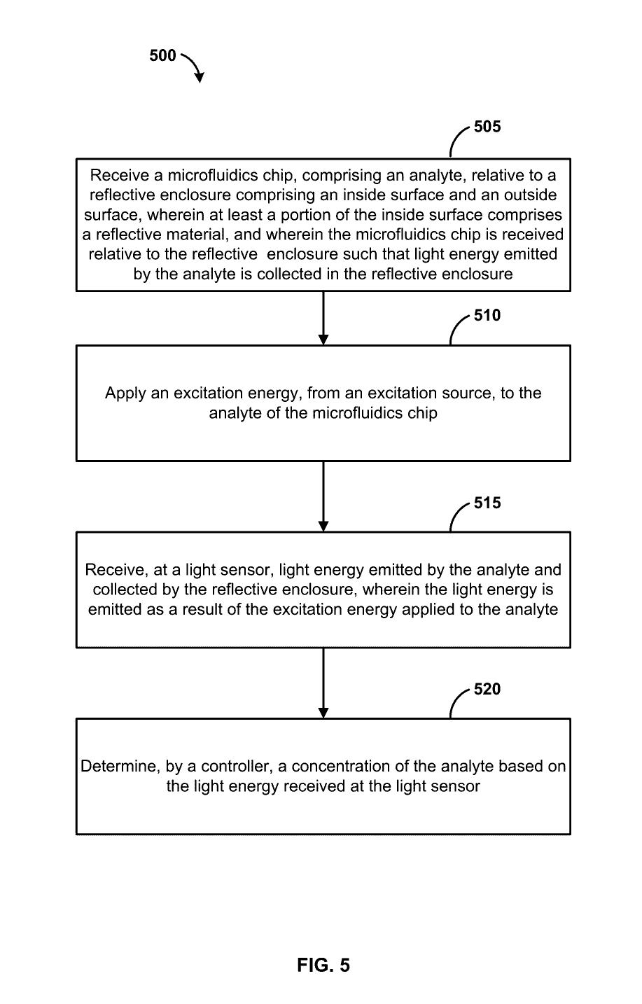

FIG. 5 illustrates an example flowchart of a method 500 according to an aspect. In an aspect, in step 505, a fluorometer can receive a microfluidics chip. In an aspect, the microfluidics chip can comprise an analyte. The reflective enclosure can comprise an inner surface and an outer surface. At least a portion of the inner surface of the reflective enclosure can comprise a reflective material. In an aspect, the reflective enclosure can be substantially spherical in shape. However, other shapes are contemplated such as a cube, a rectangular prism, a pyramid, and the like. The microfluidics chip is received relative to the reflective enclosure such that light energy emitted by the analyte is collected in the reflective enclosure.

In step 510, an excitation source of the fluorometer can apply excitation energy to the analyte of the microfluidics chip. In an aspect, the excitation source can comprise a light source, (e.g., LED, laser, and the like). The excitation energy can be light energy produced by the light source. In an aspect, the excitation source can comprise an electrical excitation source. The electrical excitation source can apply an electrical current as excitation energy to the analyte which can cause electrofluorescence. Therefore, the electrical current can cause the analyte to emit light energy.

In step 515, a light sensor of the fluorometer can receive tight energy emitted by the analyte and collected by the reflective enclosure. The light energy is emitted by the anal e as a result of the excitation energy applied to the analyte. In an aspect, the tight sensor can be positioned inside the reflective enclosure to receive the light energy emitted from the analyte. In an aspect, the light sensor can be positioned outside the reflective enclosure and the reflective enclosure can comprise an aperture through which the light energy can pass through to be received by the light sensor. The light sensor can comprise a photo-multiplier tube, a ‘photo-diode, a photo-transistor, a CdS photocell, a photo-conductor, an integrated circuit, a sensor electronic assembly, a complimentary metal-oxide semiconductor (CMOS) sensor, a charged coupled device (CCD), combinations thereof, and the like.

In step 520, a controller can determine a concentration of the analyte based on the light energy received at the light sensor. If the light sensor receives light energy, the light sensor can generate an electrical signal that can be transmitted and received by the controller. In an aspect, the controller can comprise a memory and a processor. In an aspect, the memory can comprise computer readable instructions such as a concentration measurement module having instructions that when executed on the processor determine concentration of the analyte based on the received light energy at the light sensor by analyzing the electrical signals received from the tight sensor. The controller can also comprise a user interface at which the controller can provide the user concentration measurements of the analyte to the user. The user interface can also be configured to receive inputs from the user to control the fluorometer.

In an aspect, the method 500 can comprise one or more filtering steps. The fluorometer can comprise one or more filters that filter certain bands of wavelengths of light energy if the excitation source comprises a light source. In an aspect, a first filter can filter light energy from the light source to restrict a band of wavelengths of the light energy from being received by the analyte. The first filter can be configured to filter a band of wavelengths of the light energy that does not cause the analyte to emit light energy while letting light energy that can cause the analyte to emit light energy to pass through the first fitter. In an aspect, a second filter can fitter light energy from the light source to restrict a band of wavelengths of light energy from being received by the light sensor. The light sensor may be configured to receive the light energy emitted from the analyte. However, the light sensor may still receive light energy from other bands of wavelengths of light energy such as those caused by the light source. Therefore, the second filter can be configured to restrict the band of wavelengths of the light energy caused by the tight source but allow through bands of wavelengths of the light energy emitted by the analyte so that the light sensor can receive the light energy emitted by the analyte and not the light source.

In an aspect, the microfluidics chip receptacle can be in fluid communication with a pump that can circulate a fluid through the microfluidics chip when the microfluidics chip is disposed in the microfluidics chip receptacle. The pump can circulate one or more fluids through the microfluidics chip by one or more inlets and one or more outlets. The fluids can comprise the sample of the analyte that can be captured by the microfluidics chip so that the fluorometer can determine the concentration of the analyte.

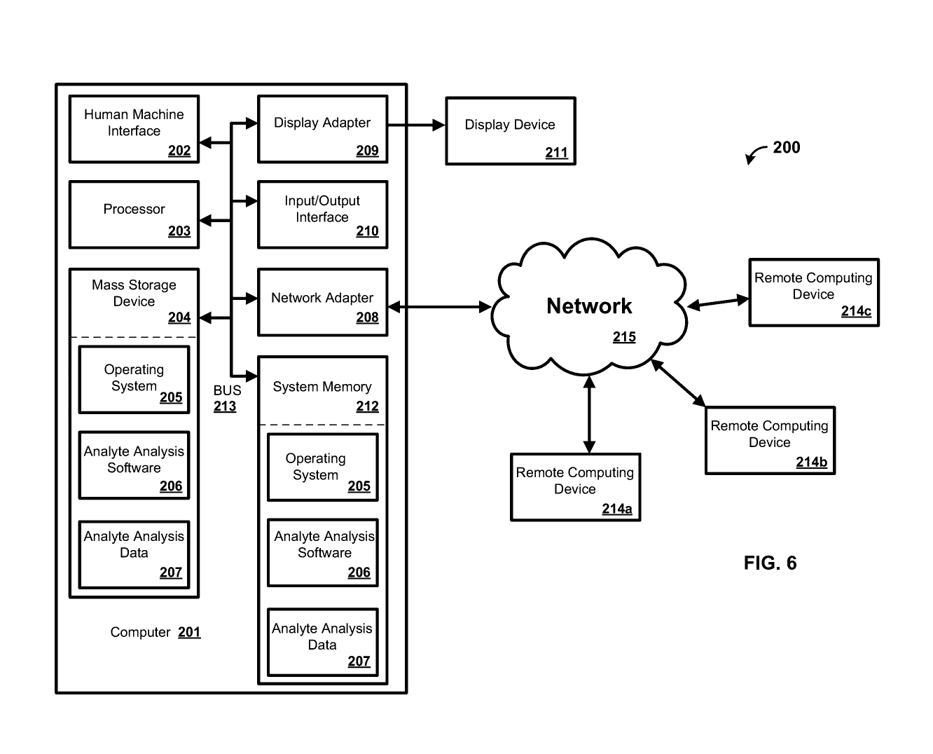

In an exemplary aspect, the methods and systems can be implemented on a computer 601 as illustrated in FIG. 6 and described below. By way of example, controller 130 of FIG. 1 can be a computer as illustrated in FIG. 6. Similarly, the methods and systems disclosed can utilize one or more computers to perform one or more functions in one or more locations. FIG. 6 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors 603, a system memory 612, and a system bus 613 that couples various system components including the one or more processors 603 to the system memory 612. The system can utilize parallel computing.

The system bus 613 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the one or more processors 603, a mass storage device 604, an operating system 605, anal e analysis software 606, analyte analysis data 607, a network adapter 608, the system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system.

The computer 601 typically comprises a variety of computer readable media. Exemplary readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as the analyte analysis data 607 and/or program modules such as the operating system 605 and the analyte analysis software 606 that are immediately accessible to and/or are presently operated on by the one or more processors 603.

In another aspect, the computer 601 can also comprise other removable/non-removable, volatile/non-volatile computer storage media. By way of example, FIG. 6 illustrates the mass storage device 604 which can provide non-volatile storage of computer code, computer readable instructions, data structures, program modules, and other data for the computer 601. For example and not meant to be limiting, the mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, the operating system 605 and the analyte analysis software 606. Each of the operating system 605 and the analyte analysis software 606 (or some combination thereof) can comprise elements of the programming and the analyte analysis software 606. The analyte analysis data 607 can also be stored on the mass storage device 604. The anal e analysis data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems,

In another aspect, the user can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the one or more processors 603 via the human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, the display device 611 can also be connected to the system bus 613 via an interface, such as the display adapter 609. It is contemplated that the computer 601 can have more than one display adapter 609 and the computer 601 can have more than one display device 611. For example, the display device 611 can be a monitor, an LCD (Liquid Crystal Display), or a projector. In addition to the display device 611, other output peripheral devices can comprise components such as speakers (not shown) and a printer (not shown) which can be connected to the computer 601 via the Input/Output Interface 610. Any step and/or result of the methods can be output in any form to an output device. Such output can be any form of visual representation, including, but not limited to, textual, graphical, animation, audio, tactile, and the like. The display device 611 and computer 601 can be part of one device, or separate devices.

The computer 601 can operate in a networked environment using logical connections to one or more remote computing devices 614a,b,c. By way of example, a remote computing device can be a personal computer, portable computer, smartphone, a server, a router, a network computer, a peer device or other common network node, and so on. Logical connections between the computer 601 and a remote computing device 614a,b,c can be made via a network 615, such as a local area network (LAN) and/or a general wide area network (WAN). Such network connections can be through the network adapter 608. The network adapter 608 can be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components reside at various times in different storage components of the computing device 601, and are executed by the one or more processors 603 of the computer. An implementation of the analyte analysis software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning. Bayesian networks, behavior based AI, neural networks, fuzzy systems, evolutionary computation (e.g, genetic algorithms), swarm intelligence (e.g. ant algorithms), and hybrid intelligent systems (e.g. Expert inference rules generated through a neural network or production rules from statistical learning).

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C., or is at ambient temperature, and pressure is at or near atmospheric.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments wilt be apparent to those skilled in the art from consideration of the specification and practice disclosed herein. It is intended that the specification and examples be considered as exemplary only, with a true scope and spirit being indicated by the following claims.

What is claimed is:

1. An apparatus comprising:
a microfluidics chip receptacle configured to receive a microfluidics chip;
a reflective enclosure comprising an outer surface and an inner surface,
wherein at least a portion of the inner surface of the reflective enclosure comprises a reflective material, and
wherein the microfluidics chip receptacle is configured in relation to the reflective enclosure so that the reflective enclosure receives, at the inner surface, light energy emitted from an analyte on a microfluidics chip disposed in the microfluidics chip receptacle;
an excitation source configured to emit an excitation energy to the microfluidics chip receptacle;
a light sensor configured in relation to the microfluidics chip receptacle to receive light energy from the microfluidics chip receptacle, wherein the light energy, caused by the excitation energy, is emitted from an analyte;
a memory comprising computer readable instructions; and
a processor that, when executing the computer readable instructions, is configured to determine a concentration of an analyte from the light energy received at the light sensor.

2. The apparatus of claim 1, wherein the excitation source comprises a light source.

3. The apparatus of claim 2, further comprising a first filter configured to restrict a band of wavelengths of light energy, generated by the light source, from being received by the microfluidics chip receptacle.

4. The apparatus of claim 2, further comprising a second filter configured to restrict a band of wavelengths of light energy, generated by the light source, from being received by the light sensor.

5. The apparatus of claim 1, wherein the excitation source comprises an electrical excitation source embedded in the microfluidics chip receptacle to accommodate electrofluorescence.

6. The apparatus of claim 1, further comprising a pump in fluid communication with the microfluidics chip receptacle configured to circulate one or more fluids through the microfluidics chip receptacle.

7. The apparatus of claim 1, wherein the reflective enclosure is substantially spherical in shape.

8. The apparatus of claim 1, further comprising a microfluidics chip disposed in the microfluidics chip receptacle.

9. The apparatus of claim 8, further comprising an analyte disposed in the microfluidics chip, wherein the analyte releases the light energy when the analyte receives the excitation energy.

10. A method comprising:
receiving a microfluidics chip, comprising an analyte, relative to a reflective enclosure comprising an inner surface and an outer surface,
wherein at least a portion of the inner surface comprises a reflective material, and wherein the microfluidics chip is received relative to the reflective enclosure such that light energy emitted by the analyte is collected in the reflective enclosure;
applying excitation energy, from an excitation source, to the analyte of the microfluidics chip;
receiving, at a light sensor, light energy emitted by the analyte and collected by the reflective enclosure, wherein the light energy is emitted as a result of the excitation energy applied to the analyte; and
determining, by a controller, a concentration of the analyte based on the light energy received at the light sensor.

11. The method of claim 9, wherein the excitation source comprises a light source and the excitation energy is light energy.

12. The method of claim 10, further comprising filtering light energy from the light source to restrict a band of wavelengths of the light energy from the light source from being received by the analyte.

13. The method of claim 10, further comprising filtering light energy from the light source to restrict a band of wavelengths of the light energy from the light source from hitting the light sensor.

14. The method of claim 9, further comprising circulating a fluid through the microfluidics chip.

15. The method of claim 9, wherein the reflective enclosure is substantially spherical in shape.

16. An apparatus comprising:
a handheld housing, comprising a microfluidics chip receptacle configured to receive a micro-fluidics chip;
a reflective enclosure disposed in the handheld container comprising an outer surface and an inner surface,
wherein at least a portion of the inner surface of the reflective enclosure comprises a reflective material, and
wherein the microfluidics chip receptacle is configured in relation to the reflective enclosure so that the reflective enclosure receives, at the inner surface, light energy emitted from an analyte on a microfluidics chip disposed in the microfluidics chip receptacle;
an excitation source configured to emit an excitation energy to the microfluidics chip receptacle;
a light sensor configured in relation to the microfluidics chip receptacle to receive light energy from the microfluidics chip receptacle, wherein the light energy is caused by the excitation energy;
a memory comprising computer readable instructions;
a processor that, when executing the computer readable instructions, is configured to determine a concentration of a analyte from the light energy received at the light sensor: and
a user interface configured to provide the concentration of the analyte to a user.

17. The apparatus of claim 15, wherein the excitation source comprises a light source.

18. The apparatus of claim 16, further comprising a first filter configured to restrict a band of wavelengths of light energy, generated by the light source, from being received by the microfluidics chip receptacle.

19. The apparatus of claim 16, further comprising a second filter configured to restrict a band of wavelengths of light energy, generated by the light source, from being received by the light sensor.

20. The apparatus of claim 15, further comprising a pump in fluid communication with microfluidics chip receptacle configured to circulate one or more fluids through the microfluidics chip receptacle.
